(19) United States
(12) Patent Application Publication
(10) Pub. No.: US 2004/0182912 A1
(43) Pub. Date: Sep. 23, 2004

(54) Wire bonder

(75) Inventors: Michael Leu, Cham (CH); Mathias Speilmann, Schenkon (CH); Ruedi Knuesel, Rotkreuz (CH); Adrian Huwiler, Huenenberg (CH)

Correspondence Address: MCCORMICK, PAULDING & HUBER LLP, CITY PLACE II, 185 ASYLUM STREET, HARTFORD, CT, 06103, US

(73) Assignee: ESEC Trading SA, Cham (CH)

(21) Appl. No.: 10/802,205

(22) Filed: Mar. 17, 2004

(30) Foreign Application Priority Data
Mar. 21, 2003 (CH) 2003 0504/03

(51) Int. Cl. B23K 31/00

(52) U.S. Cl. 228/180.5

(57) ABSTRACT

A Wire Bonder is designed in such a way and equipped with the appropriate means so that in production the current bond cycle is completed in all possible cases such as interruption of the electrical power supply, failure of the compressed air, failure of the vacuum, actuation of the emergency switch, triggering a stop signal caused by the response of a safety mechanism. A bond cycle is to be understood as one single bonding process with which the bond wire is attached to a connection point of the semiconductor chip, formed into a wire loop and attached to a connecting point of the substrate and with which the wire is then tom away from the finished wedge bond.

Applicant hereby claims foreign priority under 35 U.S.C § 119 from Swiss Application No. 2003 0504/03 filed Mar. 21, 2003, the disclosure of which is herein incorporated by reference.

### FIELD OF THE INVENTION

A Wire Bonder is a machine with which semiconductor chips are wired to a substrate after mounting. The Wire Bonder has a capillary that is clamped to the tip of a horn. The capillary serves to attach the wire to a connection point of the semiconductor chip and to a connection point of the substrate as well as to guide the wire between the two connection points. On producing the wire connection between the connection point of the semiconductor chip and the connection point of the substrate, the end of the wire protruding out of the capillary is first melted into a ball. Afterwards, the wire ball is attached to the connection point of the semiconductor chip by means of pressure and ultrasound. In doing so, ultrasound is applied to the horn from an ultrasonic transducer. This process is called ball bonding. The wire is then pulled through to the required length, formed into a wire loop and soldered to the connection point of the substrate. This last part of the process is called wedge bonding. After attaching the wire to the connection point of the substrate, the wire is torn off and the next bond cycle can begin.

Apart from the main switch with which the supply of electrical power is switched on and off, a Wire Bonder also has an emergency switch (Emergency Stop) on the actuation of which all motors are stopped instantaneously. The emergency switch serves to keep any injuries to the operating personnel and/or damage to the Wire Bonder as low as possible in the event of a failure. The emergency switch alone however is not capable of guaranteeing the safety of the operating personnel when those zones of the Wire Bonder where parts are moved at high speed are not completely covered in order to prevent access by the operating personnel. Such zones are for example the working area of the bondhead or the working area of the magazine robots.

The object of the invention is to develop a Wire Bonder that on the one hand fulfils the current safety standards, in particular the European Union (EU) directives and, on the other hand, excludes the production of waste even in critical situations.

### SUMMARY OF THE INVENTION

According to the invention those zones of the Wire Bonder where parts are moved at high speed are equipped with suitable safety mechanisms in order to eliminate the danger of, for example, a finger or a hand of an operator being trapped and injured. To do this, the working area of the bondhead is protected against access by the operating personnel on the one hand by mechanical means and, on the other hand, by means of a light curtain. As soon as the light curtain is interrupted, a signal is produced that leads to an immediate controlled stop of the Wire Bonder. These safety mechanisms now guarantee compliance with the EU directives. However, there is a grave disadvantage in that such an instantaneous stop of the Wire Bonder in production occurs with great probability in the midst of a bond cycle. The semiconductor chip being wired would then have to be thrown away as waste when further particular measures are not taken. In accordance with the invention, this disadvantage is rectified in that the stop signal becomes only effective when the currently running bond cycle is completed.

The working area of the magazine robots, ie, the transport systems that supply and remove the magazines with the substrates, is protected by at least one mechanical switch that reacts as soon as the movement of the magazine robot meets with a resistance of a predetermined force. Triggering of such a mechanical switch results in the drive of the affected magazine robot being stopped immediately.

For operation, the Wire Bonder must be supplied with electrical power, compressed air, possibly also with vacuum and, under certain circumstances, also with an inert gas. In order that, on a power failure as well as on failure of the vacuum, the Wire Bonder can complete the current bond cycle, in accordance with the invention an electrical power supply module and if necessary a vacuum tank are present that take over the electrical power supply and the supply of vacuum for a specific minimum length of time τ that is sufficient in each case to complete the current bond cycle and, optionally, for a controlled shutdown of the Wire Bonder. This period of time τ amounts typically to around 200 milliseconds for the power supply whereby 120 milliseconds are reserved for completing the bond cycle and 80 milliseconds for the controlled shutdown of the Wire Bonder or 250 milliseconds for the supply of vacuum by means of the vacuum tank. In addition, appropriate sensors are present in order to detect a power failure as well as a failure of the compressed air or the vacuum. On failure of the compressed air, the compressed air present in the supply line is sufficient to complete the current bond cycle when the sensor reports the failure of the compressed air in good time.

Summarised therefore, the invention consists of designing a Wire Bonder in such a way and equipping it with the corresponding means so that in production the current bond cycle is completed in all possible cases such as interruption of the electrical power supply, failure of the compressed air, failure of the vacuum, actuating the emergency switch, triggering a stop signal caused by the response of a safety mechanism. As described in the introduction, a bond cycle is to be understood as one single bonding process with which the bond wire is attached to a connection point of the semiconductor chip, formed into a wire loop and attached to a connection point of the substrate and with which the wire is then also tom away from the finished wedge bond. Preferably, the status of the finished wire loops of the processed semiconductor chip is saved in addition.

Therefore when, for example, a semiconductor chip with ten wires is to be connected to a substrate and when, during production of the fifth wire connection, one of the above mentioned faults occurs, then the fifth wire connection will still be produced while production of the remaining wire connections six to ten no longer takes place.

The invention offers the advantage that, after rectifying the fault that led to the interruption, wiring of the current semiconductor chip can be completed without problem.

The invention will now be explained in more detail based on the example of a Wire Bonder for the production of wire connections with a horizontally aligned glide plate and a rotary bondhead gliding on the glide plate. Such a bondhead is described in U.S. Pat. No. 6,460,751 explicit reference to which is made here. The bondhead consists of a carriage, a rotary support and a rocker. A horn to which ultrasound is applied is attached to the rocker and a capillary guiding the wire is clamped to its tip. The carriage bears on the slide plate by means of a first vacuum pre-charged air bearing and on a bearing element that is aligned parallel to a direction designated as y direction by means of a second vacuum pre-charged air bearing. The pre-charging of the two air bearings with vacuum has the effect that the carriage not only bears on but is also pulled against the slide plate or bearing element with a predetermined force: Movement of the carriage is only possible in the y direction and takes place practically without friction.

The carriage moves the rotary support back and forth in y direction. The rotary support bears on the carriage and can be rotated on a vertical axis that moves with the carriage in y direction. The rotary support also bears on an air bearing. The rotary support can be rotated by an angle θ of around ±15° in relation to the y direction. The rocker that can be rotated on a horizontal axis is mounted on the rotary support. The carriage and the rotary support enable movement of the capillary in a predetermined area within the horizontal plane. The rocker enables movement of the capillary in vertical direction.

Furthermore, the Wire Bonder has a transport system that transports the substrate from a first magazine robot to the bonding station and from the bonding station to a second magazine robot. The transport direction is designated as x direction.

On movement of the bondhead in y direction, a large mass is moved back and forth at great speed. If an operator brings a finger or a hand within the movement range of the bondhead, then the danger exists that the bondhead traps the finger or the hand with full force whereby the finger or hand could be severely injured. On the other hand, a further danger exists in that the transport system that transports the substrates in x direction could injure the finger or hand of the operator. For this reason, the Wire Bonder is equipped with a light curtain that protects the working area of the bondhead from unauthorised access. As soon as the light curtain is interrupted, a signal is produced that on the one hand instructs the control program of the Wire Bonder to only complete the current bond cycle and then to interrupt the wiring of the current semiconductor chip and on the other hand makes sure that the power supply of the motor that drives the carriage of the bondhead and the power supply of the motor of the transport system for the forward feed of the substrate are interrupted after a predetermined length of time τ. The period of time τ is calculated so that on the one hand it is sufficient in order to complete the current bond cycle and on the other hand is so short that the bondhead or the transport system are stopped before the finger or hand can be seriously injured.

The two magazine robots can each move one magazine in horizontal direction, namely in y direction and in vertical direction, namely in the direction designated with z. Because the movement area of the two magazine robots is freely accessible, a safety mechanism is also present here that ensures that the movement of the corresponding magazine robot is stopped instantaneously when the movement meets with a resistance that exceeds a predetermined force. However in this case, it suffices to stop the two motors of the respective magazine robot, whereas the bond cycle can continue without problem.

There are three further fault cases with which it must be ensured that the current bond cycle is completed. These three fault cases are: Failure of the electrical power supply, failure of the pneumatic power supply (failure of the vacuum and/or compressed air) and actuation of the emergency switch. In order that, on a power failure as well as with a failure of the vacuum, the Wire Bonder can complete the current bond cycle, in accordance with the invention an electrical power supply module and a vacuum tank are present that can take over the electrical power supply or the supply of vacuum for a specific minimum length of time τ₁ or τ₂ that suffices in each case in order to complete the current bond cycle and, optionally, for a controlled shutdown of the Wire Bonder. The period of time τ₁ for the electrical power supply module amounts typically to around 200 milliseconds whereby 120 milliseconds are reserved for completing the bond cycle and 80 milliseconds for the controlled shutdown of the Wire Bonder. The period of time τ₂ for the vacuum tank amounts typically to around 250 milliseconds.

The condition of the external electrical power supply is monitored by means of a sensor. When the external power supply fails (unplanned), then the power supply module automatically takes over the power supply for the Wire Bonder and the sensor produces a corresponding signal that on the one hand informs the control program that the external power supply has failed and on the other hand performs a delayed hardware switch-off on the power modules that supply the drives with electrical power. The delay amounts typically to around 200 milliseconds. The power modules are therefore only switched off when the current bond cycle has been completed.

The vacuum tank is arranged between the external vacuum supply and the Wire Bonder. The external vacuum supply therefore supplies the vacuum tank with vacuum and the vacuum tank supplies the Wire Bonder with vacuum. The vacuum tank has a valve on the side facing towards the external vacuum supply that is open during normal operation. The condition of the external vacuum supply is monitored by means of a sensor. Because the bondhead, as described above, glides on an air bearing preloaded with vacuum, the condition of the vacuum in this area is also monitored by means of a sensor integrated into the bondhead. When the first sensor reports a failure of the external vacuum supply or when the second sensor reports a failure of the vacuum in the area of the bondhead, then the valve of the vacuum tank is closed instantaneously. The vacuum tank is dimensioned so that the vacuum present within it suffices in order to operate the Wire Bonder long enough until the current bond cycle is completed. The valve of the vacuum tank is designed so that it is closed in the de-energised condition.

A further sensor monitors the condition of the compressed air. The compressed air is required for various tasks in particular the supply of the air bearings of the bondhead or the pre-tensioning of the bond wire. The sensor is arranged so far away from the air bearings of the bondhead that the amount of compressed air still present in the tube between the sensor and the air bearings is sufficient to complete the current bond cycle. When the sensor detects a fall in the compressed air, then the control program still completes the current bond cycle and afterwards stops all drives of the bondhead. In this way, possible damage to the air bearings of the bondhead is prevented.

When the emergency switch is actuated, then a signal is produced that on the one hand instructs the control program to complete the current bond cycle and then to interrupt the further wiring of the semiconductor chip and, on the other hand, performs a delayed hardware switch-off on all power modules that supply the drives with electrical power.

This concept will now be illustrated based on the drawing.

### BRIEF DESCRIPTION OF THE DRAWING FIGURE

The accompanying drawing, which is incorporated into and constitutes a part of this specification, illustrates an embodiment of the present invention and, together with the detailed description, serves to explain the principles and implementations of the invention.

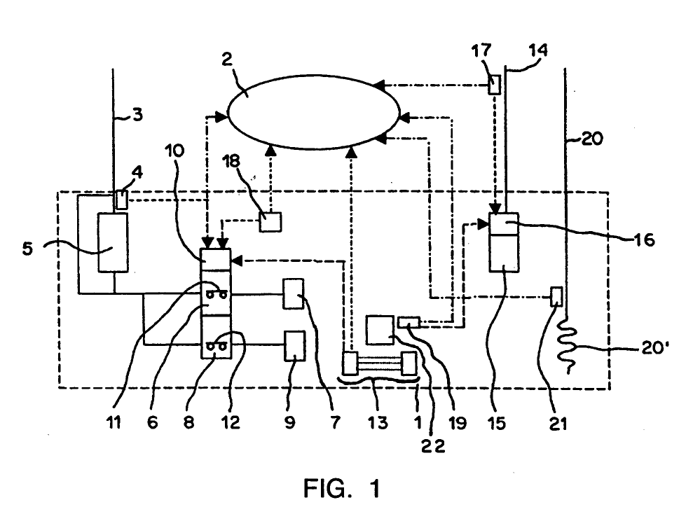

In the drawing FIG. 1 shows a schematic of a Wire Bonder.

### DETAILED DESCRIPTION OF THE PREFERRED EMBODIMENT

The FIGURE shows schematically and so far as is necessary for the understanding of the invention on the one hand the hardware I and the software 2 or the control program of the Wire Bonder and, on the other hand, with broken or chain dot arrows the signals and their paths that control the processes described above. The electrical power is supplied via a line 3 whereby a sensor 4 monitors the voltage on the line 3. The power supply module is designated with the reference numeral 5 that on failure of the external power supply takes over the power supply of the Wire Bonder for the predetermined period of time_{—1}. The reference numeral 6 designates a first power module for the drive 7 of the carriage of the bondhead. The reference numeral 8 designates a second power module for the drive 9 of the transport system for transporting the substrates in x direction. The two power modules 6 and 8 each contain a switch 11 or 12 controlled from a common timer 10. The switches 11 and 12 are preferably located at the input of the respective power module 6 or 8, so that the supply of electrical power to the power module 6 or 8 is interrupted when the respective switch 11 or 12 is open. Alternatively the switches 11 and 12 could also be located at the output of the respective power module 6 or 8, so that the supply of electrical power to the drive 7 or 9, respectively, is interrupted when the respective switch 11 or 12 is open. The working area of the bondhead is protected against inadvertent access by the light curtain 13. The supply of vacuum from the external vacuum supply takes place via a line 14 whereby a vacuum tank 15 is arranged in the line 14. The vacuum tank 15 has a valve 16 on the side facing towards the external vacuum supply. The strength of the vacuum at the inlet of the vacuum tank 15 is monitored by means of a sensor 17. A further sensor 19 monitors the strength of the vacuum in the area of the bondhead where the vacuum is required for preloading the air bearings. The emergency switch is designated with the reference numeral 18. It is of course possible that not only one single emergency switch is present but that several emergency switches are present. The supply of compressed air takes place via a supply line 20. A pressure sensor 21 monitors the pressure in the supply line 20. In the example, the pressure sensor 21 is arranged around one metre away from the air bearings of the bondhead. The volume of the supply line 20′ between the pressure sensor 21 and the air bearings of the bondhead serves as a compressed air reservoir that on failure of the compressed air supply suffices to be able to complete the current bond cycle.

The activities triggered by the events described above are presented by broken lines with arrows. These events are:

1. Failure of the External Electrical Power Supply

The sensor 4 produces a signal that indicates the failure of the external electrical power supply. This signal is fed to the control program 2 whereupon, after completion of the current bond cycle, the control program 2 suspends the further wiring of the current semiconductor chip and, preferably, shuts down the Wire Bonder as quickly as possible. The controlled shutdown of the Wire Bonder has the effect that the Wire Bonder only continues with the wiring when the operating personnel has switched the Wire Bonder on again. This means that no waste is produced either by a short-term failure or by a failure of longer duration of the external power supply.

With a preferred embodiment, the control program 2 ensures that all electrical consumers that are not necessary to complete the current bond cycle are immediately shut down when the sensor 4 indicates a failure of the external power supply. Such consumers that are not necessary for completion of the current bond cycle are for example the magazine robots or a heater that heats the substrate to the temperature necessary for bonding, etc. This solution offers the advantage that the power supply module 5 only has to be designed for operation of those electrical consumers that are absolutely necessary for completing the current bond cycle.

2. Failure of the External Vacuum Supply or Drop of the Vacuum In the Air Bearings of the Bondhead

When the sensor 17 reports a drop in the vacuum of the external vacuum supply or sensor 19 a drop in the vacuum in the air bearings of the bondhead below a predetermined value, then this is reported on the one hand to the control program 2 so that, after completion of the current bond cycle, the control program 2 suspends the further wiring of the semiconductor chip. On the other hand, the valve 16 on the vacuum tank is closed instantaneously.

3. Failure of the External Compressed Air Supply

When the pressure sensor 21 detects that the pressure of the compressed air falls below a predetermined value, then it reports this to the control program 2. The control program 2 then completes the current bond cycle and afterwards stops all drives of the Wire Bonder.

4. Interruption of the Light Curtain 13, and

5. Actuation of the Emergency Switch 18

An interruption of the light curtain 13 or actuation of one of the emergency switches 18 is reported on the one hand to the control program 2 and, on the other hand, to the timer 10. Both events cause the control program 2 to complete the current bond cycle and then to suspend the further wiring of the semiconductor chip. After completion of the bond cycle, the control program 2 additionally stops the drive 7 for the carriage of the bondhead and the drive 9 for the transport system for the substrates. Furthermore, both events start a counter in the timer 10. As soon as the counter exceeds a predetermined value which means that a predetermined time interval has elapsed, the timer 10 opens the two switches 11 and 12 so that the drive 7 for the carriage of the bondhead and the drive 9 for the transport system for the substrates are isolated from the power supply and therefore stop instantaneously.

If the Emergency switch 18 has been actuated, then the hardware 1 additionally makes sure that all electrical consumers of the Wire Bonder that are not required for completing the bond cycle are immediately switched off.

6. Triggering the Safety Mechanism On a Magazine Robot

If the movement of a magazine robot in y direction or in z direction meets with a resistance that is greater than a predetermined force then the safety mechanism is triggered for the affected magazine robot. Such a safety mechanism consists for example of an electromechanical switch that interrupts the power supply to the corresponding drive. The position of this switch is monitored by the hardware 1. If the safety mechanism is triggered, then the hardware 1 makes sure that the movement of the affected magazine robot is immediately stopped. Furthermore, the wiring of semiconductor chips is suspended as soon as wiring of the last semiconductor chip on the current substrate has been completed.

Processing of the described events by the control program 2 can be carried out in different ways. One possibility exists in that, before the start of a new bond cycle, the control program 2 always checks whether such an event has been reported or is indicated. The new bond cycle will only be commenced when no such event has been reported. Otherwise, the control program 2 introduces the measures described above.

There are also Wire Bonders that require no vacuum. In this case, the vacuum tank and the corresponding measures can be omitted.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims and their equivalents.

What is claimed is:

1. Wire Bonder for wiring semiconductor chips, comprising
a bondhead,
a power module supplying electrical power for operating a drive of the bondhead,
a power switch for controlling the supply of electrical power bythe power module to the drive,
a timer,
a control program, and
at least one emergency switch,
the at least one emergency switch producing upon activation a signal for causing the control program to complete a current bond cycle and then suspend the further wiring and for starting the timer, the timer opening the power switch after a predetermined period of time has elapsed, the predetermined period being sufficient to complete the current bond cycle.

2. Wire Bonder according to claim 1, further comprising
an electrical power supply module guaranteeing on interruption of an external power supply the supply of electrical power to the Wire Bonder for a minimum predetermined period of time, and
a sensor for detecting a possible interruption of the external power supply, the control program completing the current bond cycle and then suspending the further wiring when the sensor reports an interruption of the external power supply.

3. Wire Bonder according to claim 2, wherein the Wire Bonder is set up to instantaneously switch off all electrical consumers not required for completion of the current bond cycle when the sensor reports an interruption of the external power supply.

4. Wire Bonder according to claim 1, further comprising a pressure sensor for measuring a pressure in a pressure supply line connected to the Wire Bonder, the control program completing the current bond cycle and then suspending the further wiring when the pressure measured by the pressure sensor falls below a predetermined value.

5. Wire Bonder according to claim 2, further comprising a pressure sensor for measuring a pressure in a pressure supply line connected to the Wire Bonder, the control program completing the current bond cycle and then suspending the further wiring when the pressure measured by the pressure sensor falls below a predetermined value.

6. Wire Bonder according to claim 3, further comprising a pressure sensor for measuring a pressure in a pressure supply line connected to the Wire Bonder, the control program completing the current bond cycle and then suspending the further wiring when the pressure measured by the pressure sensor falls below a predetermined value.

7. Wire Bonder according to claim 1, further comprising at least one vacuum sensor for monitoring a vacuum and a vacuum tank guaranteeing the supply of vacuum to the Wire Bonder for a minimum predetermined period of time on an interruption of an external vacuum supply, the control program completing the current bond cycle and then suspending the further wiring when the vacuum measured by the vacuum sensor falls below a predetermined value.

8. Wire Bonder according to claim 2, further comprising at least one vacuum sensor for monitoring a vacuum and a vacuum tank guaranteeing the supply of vacuum to the Wire Bonder for a minimum predetermined period of time on an interruption of an external vacuum supply, the control program completing the current bond cycle and then suspending the further wiring when the vacuum measured by the vacuum sensor falls below a predetermined value.

9. Wire Bonder according to claim 3, further comprising at least one vacuum sensor for monitoring a vacuum and a vacuum tank guaranteeing the supply of vacuum to the Wire Bonder for a minimum predetermined period of time on an interruption of an external vacuum supply, the control program completing the current bond cycle and then suspending the further wiring when the vacuum measured by the vacuum sensor falls below a predetermined value.

10. Wire Bonder according to claim 4, further comprising at least one vacuum sensor for monitoring a vacuum and a vacuum tank guaranteeing the supply of vacuum to the Wire Bonder for a minimum predetermined period of time on an interruption of an external vacuum supply, the control program completing the current bond cycle and then suspending the further wiring when the vacuum measured by the vacuum sensor falls below a predetermined value.

11. Wire Bonder according to claim 5, further comprising at least one vacuum sensor for monitoring a vacuum and a vacuum tank guaranteeing the supply of vacuum to the Wire Bonder for a minimum predetermined period of time on an interruption of an external vacuum supply, the control program completing the current bond cycle and then suspending the further wiring when the vacuum measured by the vacuum sensor falls below a predetermined value.

12. Wire Bonder according to claim 6, further comprising at least one vacuum sensor for monitoring a vacuum and a vacuum tank guaranteeing the supply of vacuum to the Wire Bonder for a minimum predetermined period of time on an interruption of an external vacuum supply, the control program completing the current bond cycle and then suspending the further wiring when the vacuum measured by the vacuum sensor falls below a predetermined value.

13. Wire Bonder according to claim 1, further comprising a light curtain for detecting any access to a working area of the bondhead, the control program completing the current bond cycle and then suspending the further wiring when the light curtain reports an interruption.

14. Wire Bonder according to claim 2, further comprising a light curtain for detecting any access to a working area of the bondhead, the control program completing the current bond cycle and then suspending the further wiring when the light curtain reports an interruption.

15. Wire Bonder according to claim 3, further comprising a light curtain for detecting any access to a working area of the bondhead, the control program completing the current bond cycle and then suspending the further wiring when the light curtain reports an interruption

16. Wire Bonder according to claim 4, further comprising a light curtain for detecting any access to a working area of the bondhead, the control program completing the current bond cycle and then suspending the further wiring when the light curtain reports an interruption.

17. Wire Bonder according to claim 5, further comprising a light curtain for detecting any access to a working area of the bondhead, the control program completing the current bond cycle and then suspending the further wiring when the light curtain reports an interruption.

18. Wire Bonder according to claim 6, further comprising a light curtain for detecting any access to a working area of the bondhead, the control program completing the current bond cycle and then suspending the further wiring when the light curtain reports an interruption.

19. Wire Bonder according to claim 7, further comprising a light curtain for detecting any access to a working area of the bondhead, the control program completing the current bond cycle and then suspending the further wiring when the light curtain reports an interruption.

20. Wire Bonder according to claim 8, further comprising a light curtain for detecting any access to a working area of the bondhead, the control program completing the current bond cycle and then suspending the further wiring when the light curtain reports an interruption.

21. Wire Bonder according to claim 9, further comprising a light curtain for detecting any access to a working area of the bondhead, the control program completing the current bond cycle and then suspending the further wiring when the light curtain reports an interruption.

22. Wire Bonder according to claim 10, further comprising a light curtain for detecting any access to a working area of the bondhead, the control program completing the current bond cycle and then suspending the further wiring when the light curtain reports an interruption.

23. Wire Bonder according to claim 11, further comprising a light curtain for detecting any access to a working area of the bondhead, the control program completing the current bond cycle and then suspending the further wiring when the light curtain reports an interruption.

24. Wire Bonder according to claim 12, further comprising a light curtain for detecting any access to a working area of the bondhead, the control program completing the current bond cycle and then suspending the further wiring when the light curtain reports an interruption.
